(19) United States
(12) Patent Application Publication
(10) Pub. No.: US 2005/0061948 A1
(43) Pub. Date: Mar. 24, 2005

(54) Method and apparatus for forming construction panels and structures

(76) Inventor: James Andrew Brennan, Henderson Auckland (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/500,937

(22) PCT Filed: Jan. 8, 2003
(86) PCT No.: PCT/AU03/00011

(30) Foreign Application Priority Data
Jan. 8, 2002 (AU) PR 9849

(51) Int. Cl. B41B 11/52

(52) U.S. Cl. 249/167; 249/139

(57) ABSTRACT

The present invention includes a formwork structure located on supporting surface, the structure having a side form perimeter including side form members, the perimeter defining a curable non-solid material retaining area; the formwork including side form support members that support the side form members, at least one of the side form support members being held in a fixed position relative to the supporting surface by a surface-to-member releasable securing device fixed to the supporting surface and which engages the side form support member, characterised in that the secured side form support member is adapted to permit another side form support member to be secured thereto by one or more releasable inter-member securing devices, which are separate to the surface-to-member securing device.

### FIELD OF INVENTION

This invention relates to formwork for use in forming construction panels and structures.

### BACKGROUND OF INVENTION

In the construction industry, panels and structures are either prepared on-site (as known as in-situ casting) or off-site (known as pre-casting).

On-site casting is typically performed by constructing temporary formwork and pouring a curable non-solid material such as concrete into the formwork. Once the concrete has cured the formwork is removed. This method can be used to make walls, slabs or kerbs.

Generally, the temporary formwork is formed from timber, in order to produce a low cost mould. In order to reduce costs in materials most formwork timbers are typically low-grade wood. These types of timbers are prone to weathering and there is often considerable variation between timbers. In order to reduce cost in labour the timbers are not recycled. A construction panel or structure cast in such formwork will normally have a poor finish and cannot be used where there are small dimensional tolerances.

Pre-cast construction panels are formed off-site, typically in dedicated construction yards and are transported to a desired work-site. They may be formed using temporary formwork of the timber type described above or may be prepared using precision equipment. The latter uses steel side-forms and casting beds to give a panel that has an improved finish and precise dimensions.

Pre-cast panels suffer from the limitation that they must be transported to the work-site for erection or use. Cranes and significant labour are required to place the panels. This significantly adds to the cost of using pre-cast panels or structures and limits the maximum size of the panel.

Both of the described on-site and pre-casting methods require skilled individuals to create the moulds and are very labour intensive. This significantly adds to the cost of either of these methods.

One successful attempt to address some of the negative aspects of both of the above construction methods is described as the Tiltform Panel System™. This system is disclosed in AU patent 721582 (A. R. Tiltform), the disclosures therein being incorporated in their entirety by cross-reference.

The Tiltform™ system uses extruded aluminium side-forms having a high degree of dimensional accuracy as the frame or mould into which concrete is poured. The side-forms have a concrete facing side with a shape that is the reverse shape of the desired edges of the concrete panels. The base of the mould is typically an underlying concrete slab.

Each of the side-forms is affixed on the non-concrete facing side to sliding risers. Each side-form will normally be affixed to a number of risers equally spaced along the length of the side-form.

Each sliding riser extending is held in position by using a setback buttress. Each buttress comprises a steel base that is bolted to the underlying concrete slab; four spaced apart fixed length uprights (which act to support or buttress the wall of risers) and is capped with a top steel plate. The buttress includes a buttress clamp consisting of a short threaded shaft passing through a threaded boss in the centre of the top plate with a handle at the upper end and a contact plate at the other. The buttress acts to support a wall of risers and is capable of clamping all of the risers into a fixed position.

The buttress frame is used with a fixed number of risers, typically five, in a vertically stacked arrangement. The clamp can be tightened to compress all five risers in a fixed position or released to allow movement of all the risers.

In use a chemical breaking agent is applied to an underlying slab and concrete is poured into the mould of side-forms to form a panel. After the concrete panel has cured, a new level of side-forms is placed on the panel, the buttress clamps are released and the next level of risers can be slid into position and affixed to the new level of side-forms. This process is repeated as desired until all five of the risers in the buttress clamp have been used.

Once the panels have all set, the formwork is removed and the panels separated and moved into position. The chemical breaking agent allows each of the layers of concrete to be separated.

Whilst the Tiltform™ system is a significant improvement over the previous methods, it has a number of significant disadvantages.

One of the main problems with this system is the need to use buttress frames as they introduce a number of limitations and requirements. The buttress frames are heavy and cumbersome and are typically delivered to building sites in stillages. This means that a large amount of space is used during transportation of the buttresses and also on site when assembled, in addition to the space for the stillages. This generally means the use of a crane or forklift to load and unload. On site it requires a substantial area as the buttresses add at least an additional 600 mm (300 mm to each side of a panel) in width and length of all formwork. This measurement may also be needed vertically, if panels of the same size are to be stacked on top of one another. This is the minimum additional space as risers are used in the buttress frames and can protrude beyond the buttress frame.

This system can also pose a real and significant site hazard. The buttress frames are top heavy so that until they are bolted down they can tip over and injure workmen during assembly of the system. They are also dangerous once affixed to an underlying surface, as workers regularly will catch clothing and themselves on the locking down handle on top of the buttress frame. Furthermore as the layered formwork may be arranged to form different sized slabs the overall formwork can create a significant site hazard with risers protruding at various heights and levels.

In addition, the frame of buttress and the risers therein can interfere with overall ease of use of the system. Setback buttresses must always be used with a minimum number of risers (normally five) in order to be able to clamp all risers into a fixed position. Accordingly, it is necessary to provide five risers for each buttress frame even if only one slab is to be poured. The additional risers and the frame of the buttresses can interfere with concrete operations including pouring the concrete as the trucks are limited to operating between two adjacent buttress frames, and finishing operations such as power trowelling. It is important to avoid hitting the buttress frames when screening the top of the slab with a power trowel as the safety edge of a power towel may contact the risers or frame and prevent the finishing of the concrete proximal to the side-forms.

### OBJECTIVES OF THE INVENTION

It is the object of the present invention to address in part or in total one or more of the problems of using the Tiltform™ system. Preferably, the solution should be capable of being incorporated into a low cost and simple to use formwork system.

### BRIEF SUMMARY OF THE INVENTION

The present invention includes a formwork structure located on supporting surface, the structure having a side form perimeter including side form members, the perimeter defining a curable non-solid material retaining area; the formwork including side form support members that support the side form members, at least one of the side form support members being held in a fixed position relative to the supporting surface by a surface-to-member releasable securing device fixed to the supporting surface and which engages the side form support member, characterised in that the secured side form support member is adapted to permit another side form support member to be secured thereto by one or more releasable inter-member securing devices, which are separate to the surface-to-member securing device.

Another form of the invention is a formwork structure located on supporting surface, the structure having a side form perimeter including side form members, the perimeter defining a curable non-solid material retaining area; the formwork including side form support members that support the side form members and being held in a fixed position relative to the supporting surface, the side form support members having a top support surface capable of supporting another side form support member thereon and a bottom resting surface for contacting the supporting surface of the formwork or another support members top support surface, characterised in that the side form support member is secured into a fixed position by using a securing device which engages to an attachment surface of the member which is a separate and distinct surface to the top support surface of the member.

The invention also includes the formwork structures of the above in the absence of the side form perimeter, that is a structure formed from side form support members. It also includes custom side form members, preferably for use in the above, side form support members, the surface-to-member securing device, the inter-member securing device and a linking device.

### BRIEF DESCRIPTION OF THE DRAWINGS

In the figures which depict various preferred aspects of the present invention:

FIG. 1 is an end view of a side form member and side form support member of the present invention.

FIG. 1a is a magnified view of a portion of FIG. 1.

FIG. 2a is a top view of the member shown in FIG. 1.

FIG. 2b is a side view of the member shown in FIG. 1.

FIG. 3a are side views of the member shown in FIG. 1 with various shaping inserts.

FIG. 3b are side views of the shaping inserts used in FIG. 3a.

FIG. 4a is a top plan view of a formwork assembly of the invention including side form members, side form support members and linking devices.

FIG. 4b is a top plan view of an alternative formwork assembly of the invention including side form members, side form support members and linking devices.

FIGS. 5 to 7 are cross-sections taken through various formwork assemblies of the present invention.

FIG. 8 is a plan view of a surface-to-member securing device.

FIG. 9 is a side view of the surface-to-member securing device of FIG. 8.

FIG. 10 is a front view of a surface-to-member securing device of the present invention. Part of a side form support member is also shown.

FIG. 11 is a front view of an alternative surface-to-member securing device of the present invention.

FIG. 12 are front, side and perspective views of an engagement unit of the present invention used with the device shown in FIG. 11.

FIG. 13 is a perspective view of a side form member fixed to a side form support member.

FIG. 14 is a side view of FIG. 13.

FIGS. 14A and 14B are magnified views of A and B respectively.

FIG. 15 is a perspective view of the key used in FIG. 14A.

FIG. 16 is a perspective view of the key used in FIG. 14B.

FIG. 17 is a perspective view of inter-member securing device of the present invention.

FIG. 18a is a side view of the inter-member securing device of FIG. 17, shown engaging and securing two side form support members.

FIG. 18b is a side view of a variation of the inter-member securing device of FIG. 17, shown engaging and securing two side form support members.

FIG. 19 is a perspective view of one side of an alternative inter-member securing device.

FIG. 20 is a perspective view of the other side of the device of FIG. 19.

FIG. 21 is a perspective view of the device of FIG. 19 fitted to two support members.

FIG. 22A is a perspective view of a linking device of the present invention.

FIG. 22B is a side view of the linking device of FIG. 22A fitted to a side form member.

FIG. 23 is a perspective view of a linking device of FIG. 22A fitted to two side form members.

FIG. 24a is a perspective view of an alternative linking device of the present invention fitted to side form members.

FIG. 24b is a perspective view of another alternative linking device of the present invention fitted to side form members.

FIG. 25 is a perspective view of an alternative linking device fitted to side form members.

FIGS. 26A to 26C are plan views of the linking device of FIG. 24b shown in various positions.

FIGS. 26D and 26E are plan views of the linking device of FIG. 25.

FIG. 27 is a perspective view of a surface-to-member securing device.

FIG. 28 is a perspective view of the surface-to-member securing device of FIG. 27 fitted to a side form support member.

FIG. 29 is a perspective view of the surface-to-member securing device of FIG. 28 and the inter-member securing of FIG. 17 fitted to a column of side form support members.

FIG. 30 is an end view of a variation of the side form member and side form support member of the present invention.

FIG. 30a is a magnified view of a portion of FIG. 30.

FIG. 31a is a top view of the member shown in FIG. 30.

FIG. 31b is a side view of the member shown in FIG. 30.

FIG. 32 is a perspective view of the member shown in FIG. 30.

FIG. 33 is a plan view of another alternative surface-to-member securing device.

FIG. 34 is a side view of the surface-to-member securing device of FIG. 33.

FIG. 35 is a front view of surface-to-member securing device of FIG. 33.

FIG. 36 is a perspective view of the surface-to-member securing device of FIG. 33.

FIG. 37 is a perspective view of a variation of the surface-to-member securing device of FIG. 33.

FIG. 38 is a plan view of the variation depicted in FIG. 37.

FIG. 39 is a front view of the variation depicted in FIG. 37, in combination with a side form support member.

FIG. 40 is a front view of another alternative surface-to-member securing device.

FIG. 41 is a plan view of the alternative depicted in FIG. 40.

FIG. 42 is a perspective view of the alternative depicted in FIG. 40.

### DETAILED DESCRIPTION OF THE INVENTION

The invention is predicated on the finding that it is not necessary to use a buttress frame in order to secure side-form support members together and support side-forms. This avoids the need to use a support frame that may interfere with pouring or finishing panels. It also avoids the need to cart, haul and fix an excessive number of support members in situations where only one or two panels are to be poured.

In essence the formwork of the invention uses a number of securing devices in order to secure a base support member to an underlying surface, and allow for the subsequent securing of another support member on top of the base support member. Additional support members (also known as risers) can also be secured to the structure by fixing them to an underlying riser.

However risers having square or rectangular cross section will not normally allow for the releasable securing of such support members to each other, and to an underlying surface without using a fixed buttress frame. The risers need to be modified or adapted to permit individual releasable securing devices to engage therewith.

To avoid ambiguity a releasable securing device does not include the use of nails and claw hammer or screws and screwdriver. It is a device that has at least two configurations, a securing configuration and an unsecured configuration.

One form of the invention is formwork structure located on supporting surface, typically a concrete slab. The structure may have a side form perimeter formed from positioned side form members in order to define a curable non-solid material retaining area. The curable material preferably concrete, but may be any other suitable material. The formwork includes side form support members for supporting the side form members. At least one of the side form support members are held in a fixed position relative to the supporting surface by one or more surface-to-member releasable securing devices fixed to the supporting surface and which engage the side form support member. The side form support member should be adapted to permit another side form member to be secured thereto, preferably on top, by one or more releasable inter-member securing devices, which are separate to the surface-to-member securing device.

Alternatively the invention may be defined as a formwork structure located on supporting surface, the structure preferably having a side form perimeter formed from side form members in order to define a curable non-solid material retaining area. The formwork includes side form support members to support the side form members; these support members being held in a fixed position relative to the supporting surface. Each of side form support members has a top support surface capable of supporting another side form support member thereon and a bottom resting surface for contacting the supporting surface of the formwork or another support members top support surface. Importantly the side form support members may be secured into a fixed position by using a securing device that engage with an attachment surface of the member which is a separate and distinct surface to the top support surface of the member.

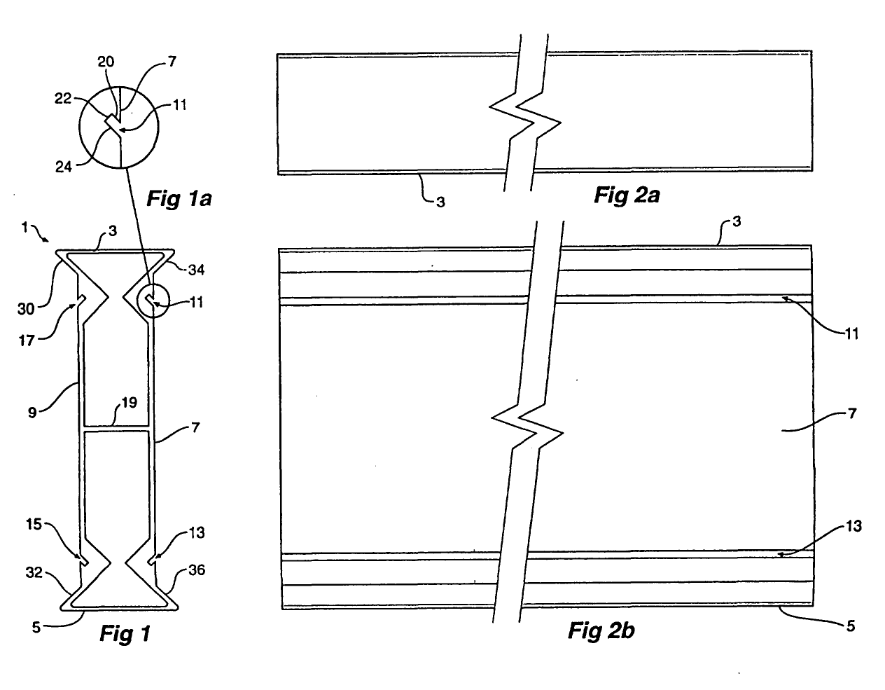

FIGS. 1 and 2 depict a side form support member suitable for use in the formwork structure of the invention. The member (1) includes a top support surface (3) and a bottom-resting surface (5). The member includes two side surfaces (7, 9) located between the support and resting surfaces. The member preferably includes a reinforcement cross member (19).

The side surfaces each include two channels (11, 13, 15, 17) therein. With reference to the magnified section, the channel (11) provides three surfaces (20, 22, 24) for possible engagement by a securing device (not shown). It is intended that the securing device may engage a portion of one or more of the surfaces. It is preferable to set the channel sides (20, 24) at an angle to the side (7) of the member so to assist in the securing engagement of a securing device to the member (1). The channel sides of the other channels should also be set at an angle. The sides (7, 9) include four fillets (30, 32, 34, 36).

In essence the side form support member should be capable of supporting a side form located on a supporting surface, where the side form constitutes part of a formwork structure for retaining curable non-solid material. The support member should have a top support surface capable of supporting another member, a bottom-resting surface for contacting and being supported by an underlying top support surface of a further member, and one or more attachment surfaces separate to and distinct from the top and bottom surfaces. The attachment surfaces should permit one or more inter-member securing devices to engage therewith and secure the member to an adjacent support member. The inter-member securing device should engage with attachment surfaces located on the adjacent support member.

It will be appreciated that it is not necessary to use a side form support member having the same design depicted in the figures. Alternative designs may be used with various types of securing devices. For example, the member may have an ‘I’ shape. One side of the flanges extending at the top and bottom of the member will be the support and rest surfaces respectively, and the opposing side of the flanges, the ones closest to the sides of a member, will provide suitable attachment surfaces for a securing device. Likewise a ‘+’ shaped member has suitable attachment surfaces on either side of the horizontal extending flanges. Alternatively the support member may have a series of slots passing there through. A securing device may be fitted to engage a portion of a surface within the slot and engage a portion of a surface of a slot in another support member.

However, it is preferred to use a support member having at least two channels on either side, with each channel running the length of the member. More preferably, the channels are set so to have attachment surfaces that are at a non-ninety degree angle to the sides.

Preferably the side form members will also have the shape shown in FIGS. 1 and 2. For cost effective manufacture of the side form members and side form support members it is preferable that they both are formed by extrusion and with the same design. The members may be formed from any suitable materials such as metal—preferably steel or aluminium, plastics, composites, even aerated concrete. Non-extruded materials could also be used such as wood. Furthermore for ease of finishing a panel of concrete and in order to pour additional panels on top of an existing panel, the side form members and the side form support members should have the same height.

One side (9) of the side form member would face the curable material, preferably concrete. The other side (7) will be supported by the support members. On the concrete facing side the fillets (30, 32) together with the side (9) can act as a mould for concrete, so that the cured material will have a shape the reverse of the shape of the side of the side form member. Such a mould would provide concrete having a chamfered rebate edge.

It is not essential to have fillet edges on the side form, nor is it to have channels. However, it is preferred to have a fillet edges, as it is desirable to make panels with a chamfered rebate edge.

Furthermore the fillets on the support side can advantageously assist in the positioning of the support members to the side form members and vice-a-versa. The ends of the support members preferably have a chamfered rebate edge that inter-fits with the shape of support side (7) of the side form members.

The channels may be omitted from the side form member. However it is preferred to include channels or some other means of providing attachment surfaces on the support side, and more preferably both sides of the side form member. It is preferred to use a channel as distinct to a flange, as a flange will is affect the shape of the corresponding concrete panel. Of course it is possible to use a flange attachment surface on the support side and a channel attachment surface on the concrete facing side.

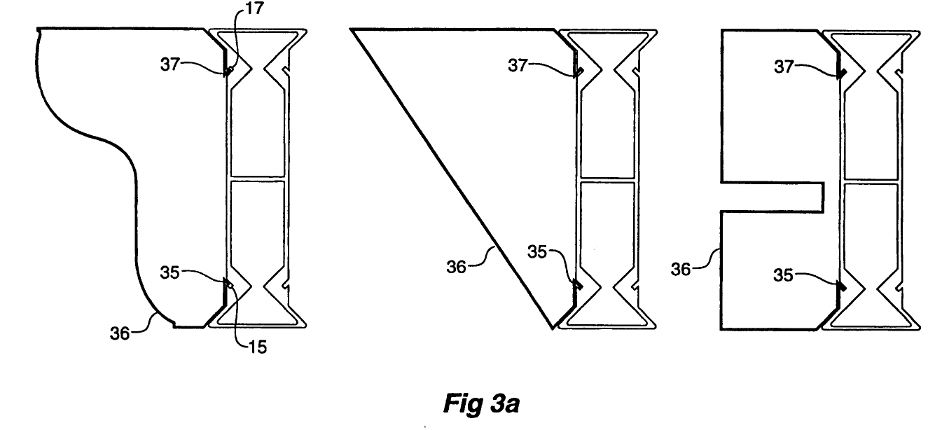

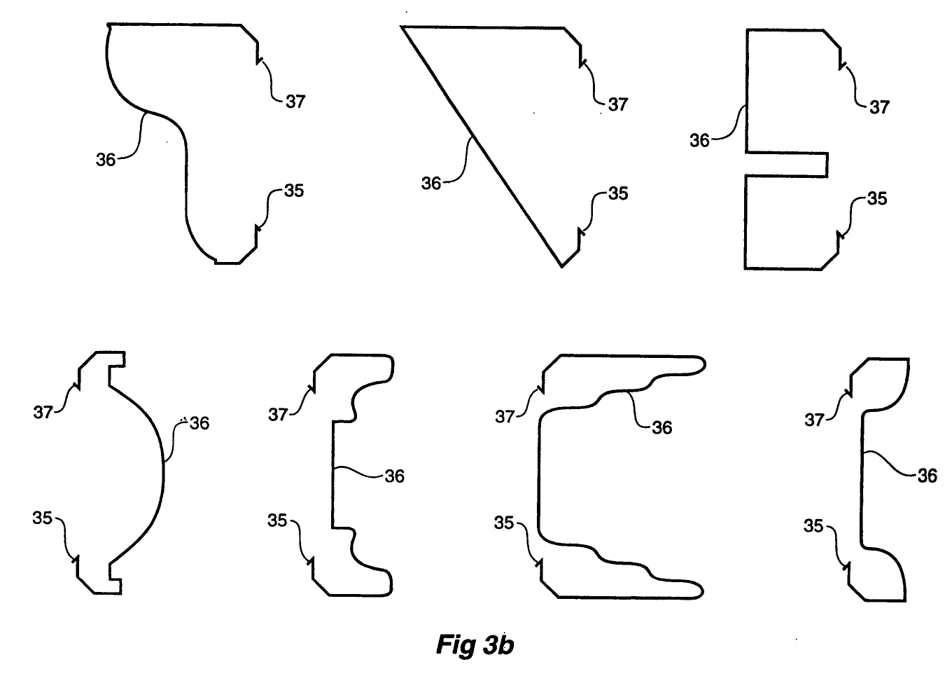

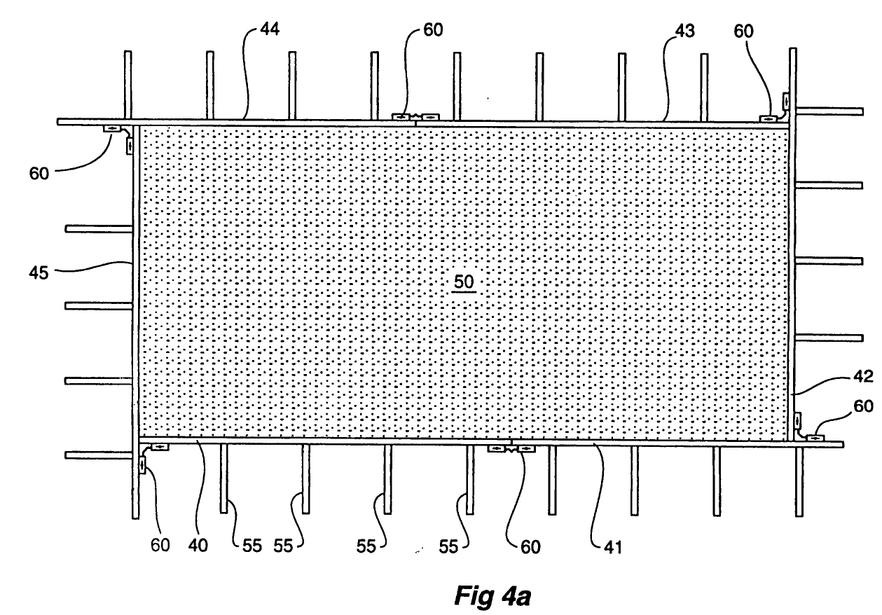

It is preferred to include an attachment surface on the concrete facing side as this permits shaping elements to be affixed to the side form member. Various shaping elements (36) are shown both affixed to the side form member in FIG. 3a, and by themselves in FIG. 3b. These elements may be clipped into the two channels (15, 17) via the flanges (35, 37) in order to provide a different edge to the formed panel. Of course the side surfaces (30, 9 and 32) form an inherent shaping element of the side form member.

Preferably the attachment surface on the concrete facing side is recessed by using a channel since this will allow the side form member to be used without a shaping element to make chamfered rebate edge. Whilst concrete may enter the channels this portion of the concrete could be broken off when the side form member is removed. Typically the side forms are removed whilst the concrete is green, for use in making another panel. The channels can also be greased (or a releasing agent applied) in order to prevent concrete from entering and to assist in the separation of the side form members from the panel.

The presence of one or more attachment surfaces on the concrete facing side of the side form member is only preferred as it is possible to provide and use a number of different shaped side forms for use in different jobs.

In a preferred form the side form member is capable of constituting part of a formwork structure for retaining curable non-solid material. It is adapted to engage and supported by a side form support member. The support member should have two opposed sides, a support side and a material facing side. The material facing side should have a shape that will provide a desirable edge shape, preferably a chamfered rebate edge, in the material. The facing side should also provide a means for attaching a shaping insert without unduly affecting the ability of the facing side to provide a desirable edge shape.

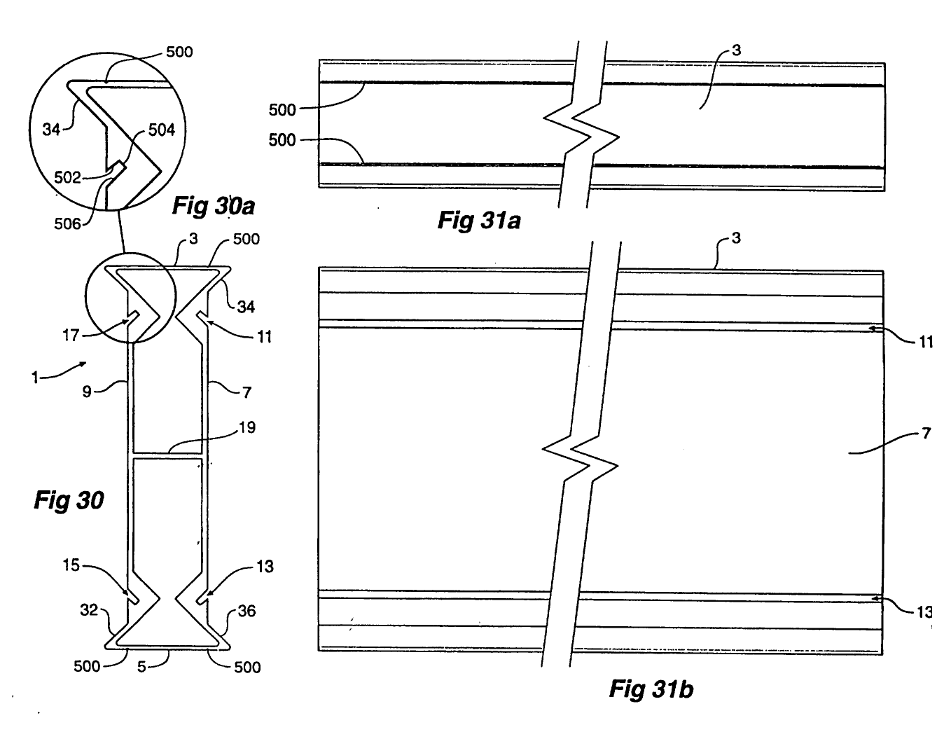

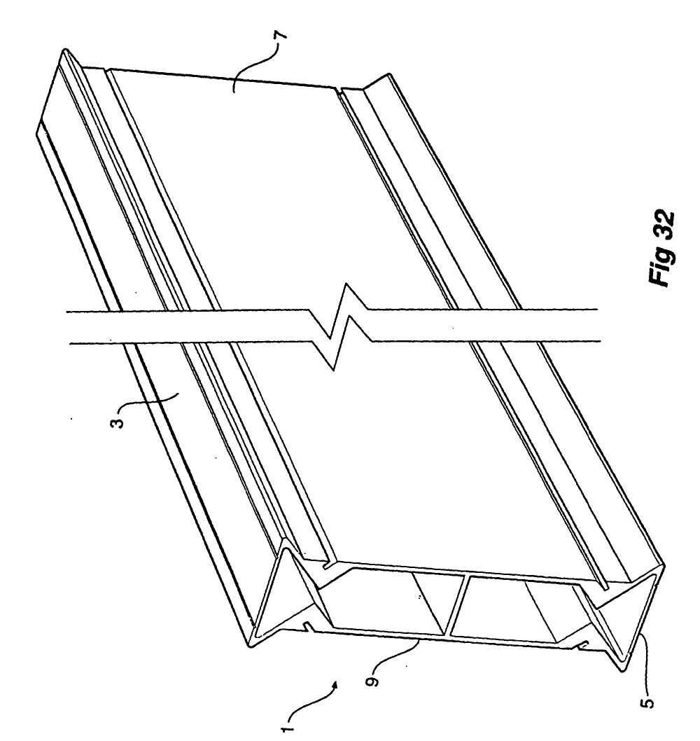

FIGS. 30 to 32 depict another form of the side form member and side form support member of the present invention. Much like that depicted in FIG. 1 the member (1) has a top support surface (3) and a bottom-resting surface (5). The member also has two side surfaces (7, 9) located between the support and resting surfaces. The member preferably includes a reinforcement cross member (19). The other reference numerals used in the figures correspond to the same features described in relation to FIGS. 1 to 3.

However the support member also includes two improvements over that earlier described in respect of FIGS. 1 to 3. The support member includes four and the bottom resting surface (5).

These channels preferably take the form of a small V cut or groove that travels along the most if not all of the length of the member. They are positioned to lie in the planes formed by the side surfaces (7, 9). Their purpose is to facilitate the sizing of panels. They provide a helpful indicator as to the location of the side surfaces of the support member and as such will facilitate the dimensioning of concrete panels.

It should be appreciated that the alternative method of establishing panel sizes is to stretch out a measuring tape between the side surfaces of the side forms defining an enclosure wherein the concrete panel is to be poured and this may require bending the tape against the face of the side form. The accurate positioning of the panels of the side forms and dimensioning of the panels is important as the tolerances may be less than 2 mm regardless of the panel size which are regularly well over 8×8 m.

It should be recognised that while the guide channels (500) are shown in both the top surface and bottom resting surface it is not necessary to have them located in the bottom surface nor is it necessary for there to be a guide indicating the location of the side of the side form that would ordinarily be supported by support members and not face securable material. In one form of the invention there would be only a single guide channel (500) located on the top support surface (3) to indicate the location of the side surface intending to contact the securable material such as concrete.

The member also includes a second improvement in respect of the channels (11, 13, 15, 17). As shown in greater detail in FIG. 30A each channel has three contact surfaces (502, 504, 506). Unlike that shown in FIG. 1 the two surfaces (502, 506) that contact the side surface (9) of the member are not parallel to each other. Instead the surfaces are arranged so that the width of the channel is greatest at its mouth and smallest at its bottom or rear surface (504). The reason for this is that if and when concrete lodges in the channel it is a relatively simple process to dislodge the concrete from such channels as compared to channels having two parallel V side surfaces. It is envisaged that the distance across the bottom of the channel (surface 504) may be 3 mm. However the distance across the two side surfaces (502 and 506) may be 5 mm when measured at the side surfaces (7,9) of the side members.

It is preferable that the uppermost side surfaces of the channels (11, 17) located nearest to the top support surface (3) and the bottommost surface or side surfaces of the channels (13, 15) closest to the bottom-resting surface (5) are set at a 45° angle to the vertical. This is preferred as most of the devices attached to the side forms will utilise this attachment surface of the channels.

The side form members may have a range of dimensions. By way of a non-limiting example the width of the side-form measured across the top and bottom surfaces from one fillet edge to the other fillet edge may be 50 mm. The width when measured from one external side face (7) to the other side face (9) may be 30 mm. Various heights of the side form may used, for example 100, 125, 150, 175 or 200 mm. Larger heights could be produced such as 300 or 400 mm if desired. The members may be produced in a wide range of lengths, as required.

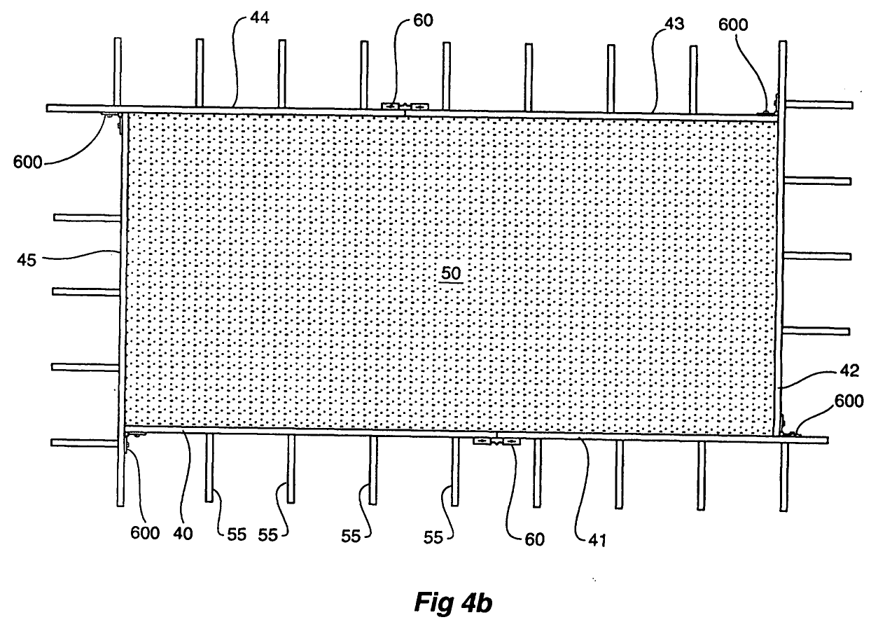

A simple formwork arrangement is shown in FIG. 4a. The side form members (40, 41, 42, 43, 44, 45) form a rectangular perimeter on a supporting surface. The curable non-solid material is poured into the region 50 in order to form a panel with a rectangular shape. The side form members are held in position by the side form support members (55). Linking devices (60) are used to hold the side form members in a fixed position to another side form member at joins between members.

FIG. 4b depicts the simple formwork of FIG. 4a, with a combination of linking devices (60) and hinge joiners (600). The linking devices (60) are used to increase the effective length of side forms whilst the hinges are used for corner joints,

FIGS. 5 to 7 depict various formwork arrangements having a plurality of layers of concrete panels. In these arrangements the bottommost side form support member (70) is secured to an underlying surface by a surface-to-member securing device (100). The bottom support member has a section (79) removed from the bottom surface and a lower side portion. This section was removed to allow the support member to be fitted over an anchor plate forming part of the surface-to-member securing device. It is envisaged that other types of securing devices could be used, including ones that would not require the removal of a section of the bottom support member.

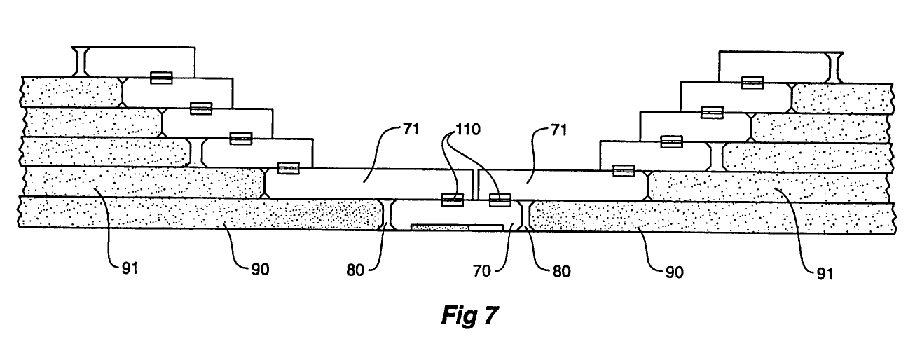

A side form member (80) would be supported by the bottom member and used in the formation of a desired perimeter for the first concrete panel (90). In most cases the side form member will be removed for re-use elsewhere once the concrete has sufficiently set. This can be done by releasing the securing device and moving the support members out of the way and then removing the side forms. In FIG. 7 the side forms have been left attached in the lowest panel.

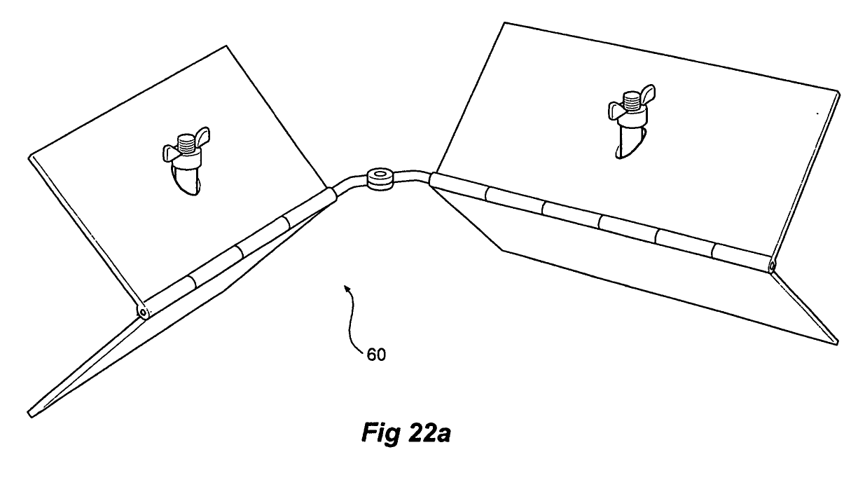

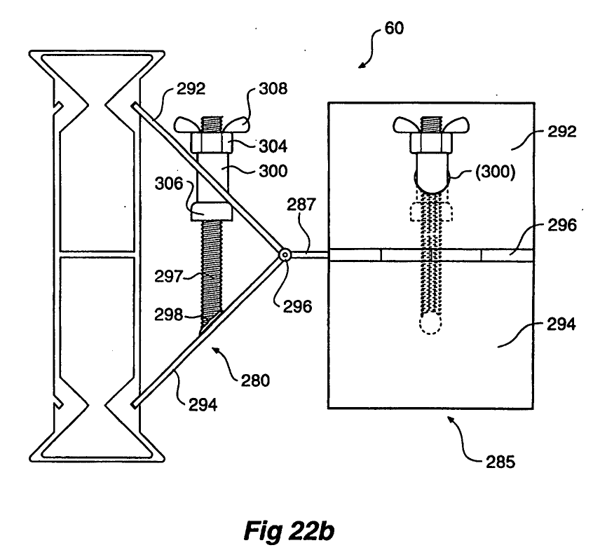

Another alternative would be to use a two-part support member. The member could include a short section at the front, near the side form members and to which the side form members would be affixed, that is capable of being linked to the remainder of the support member, such as via a linking device shown in FIG. 22A. After pouring the concrete, the side forms would be released from the short section; the short section would be released from the remainder of the support member and removed, to create room for the extraction of the side forms.

Once a first panel (90) has sufficient set, the panel may be finished with a power trowel (a mechanical concrete finishing device). As there is no need to have additional support members fitted before this time and since there are no upright buttress stands the finishing step can be performed without obstruction. The panel is then treated with a breaking agent so that the upper surface of the panel may be used as a supporting surface for another panel.

In order to pour another panel, a layer of support members (71) is releasibly secured by member-to-member securing devices (110) to a secured bottom layer (70) of support members and side forms (80) are fitted thereto. The securing devices should not impinge on the top surface of the support members in order to allow additional support members to be fitted to on the top surface. Another panel (91) may then be poured on top of the existing panel (90). These steps can be repeated again and again to make additional panels.

In most cases the side forms will be removed after the panel has been set and the support member for that layer of panel may be repositioned. An example of this can be seen in the second layer of FIG. 7. As can be seen from this figure it is possible to work on both ends of the bottom support member (70).

Importantly as the support members can be simply positioned before and after a panel has set, it permits the formation of a range of new types of panels that would have previously required off-site manufacture. Inserts and overhangs may be made on demand on-site. FIG. 5 shows an example of such an arrangement. Here a three-layer formwork structure has been prepared in order to form a panel having a double thickness section. A first shaping element (120) has been affixed to and across the first two layers of side form members (80, 81) that are supported by support members (70, 71). This shaping element provides a straight face.

The third layer of support members (72) extends over the two-layer section and a side form member (82) is affixed thereto. To the side form member is affixed a shaping element that extends downwardly for the length of a panel. The concrete may then be poured into the mould to form the desired panel.

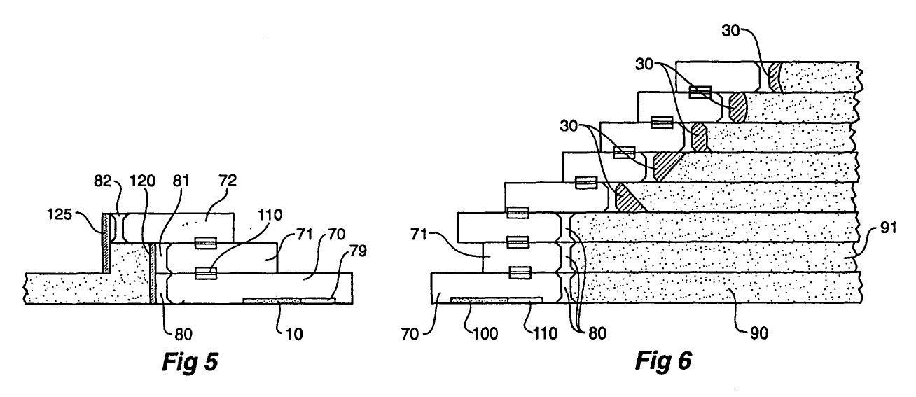

FIG. 6 shows a series of panels and highlights yet another advantage of this system. When the surface-to-member securing device is separate and distinct to the inter-member securing devices, it is possible to locate and secure support members (and thereby a side form member) away from the location of the surface-securing device. Accordingly it is possible to make smaller and smaller panels on top of earlier panels without using very long support members. FIG. 6 also demonstrates the use of various shaping inserts (30).

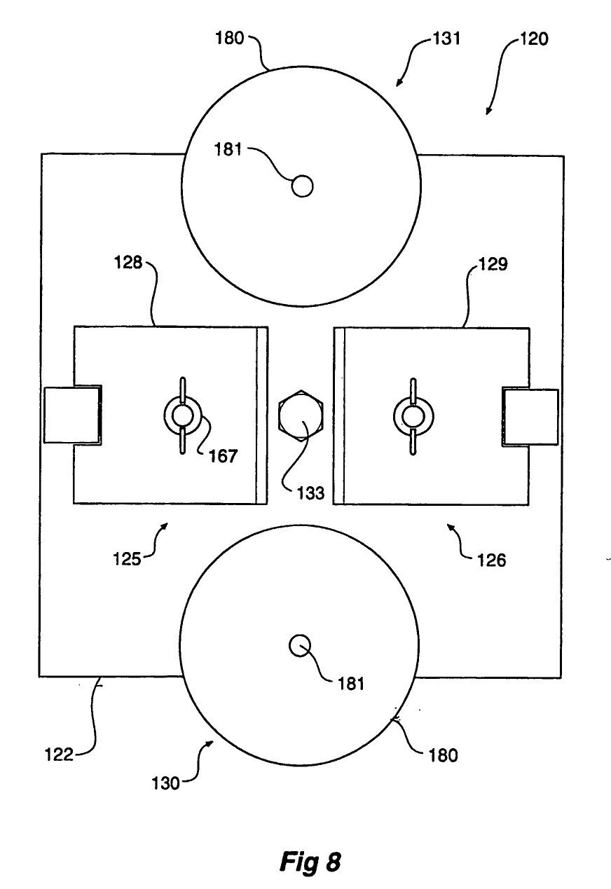

A surface-to-member securing device is shown in FIGS. 8, 9 and 10.

Essentially the device (120) is for use with formwork structures in securing side form support members which have a top support surface and has a base plate (122) for securing to an underlying supporting surface, at least one clamping element (125, 126) joined to the plate and capable of releasibly securing a side form support member, wherein the clamping element includes at least one arm (128, 129) that is capable of engaging an attachment surface of the member which is a separate and distinct surface to the top support surface of the member. Preferably the device also includes a level adjustment means (130, 131) for modifying the level of a side form support member secured to the device. In use the base plate would be secured to an underlying surface (134) about a securing point, preferably by bolting the plate down with a bolt (133) and the level adjustment means (130 or 131) is connected to the base plate and includes at least one leg (135 or 136) of an adjustable length capable of contacting the underlying surface. Adjusting the length of the leg should pivot the base plate about the securing point and change the level of the base plate and side form support members attached thereto. One method of adjusting the length of the leg would be to use a wheel (180) and threaded shaft (181) arrangement. The rotation of the wheel should move the shaft up or down relative to the base plate and thereby change the length of the shaft (135, 136) beyond the bottom of the base plate. This approach would require that the anchor plate is capable of some movement relative to the underlying surface. An alternative, and preferred method, is to have the threaded shafts (181) welded onto the anchor plate (122). The end of the threaded shafts may be flush with the bottom surface of the anchor plate or may protrude there through. In the latter arrangement, the anchor plate would include a number of contact points for supporting the plate on an underlying surface. However, the anchor plate would be incapable of any relative movement to the underlying surface. Instead, the wheels (180) would be used to adjust the position of a side form support member relative to the underlying surface. The wheels (180) would contact an under edge or surface of the bottom side form support member. The wheels (180) can move up and down the shafts and thereby adjust the level of a support member supported on the wheels.

More particularly as shown in the figures, this device has two clamping elements (125, 126). Each of these elements includes an arm (128, 129). It is envisaged that these arms may be fixed, loosely fixed, hingably fixed at one end.

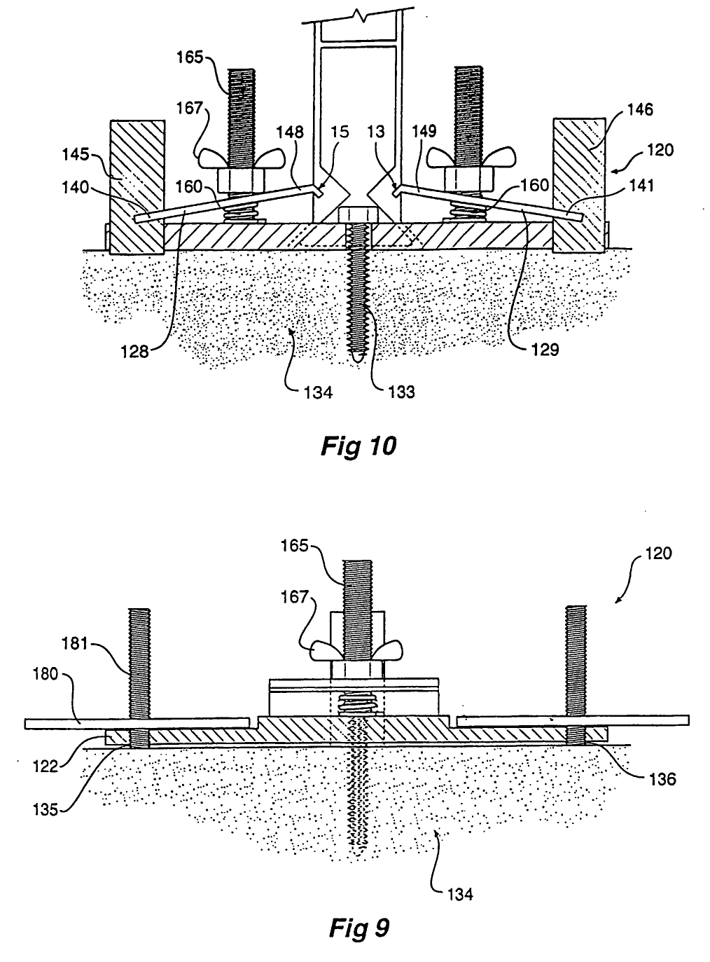

Alternatively, and as depicted in the FIGS. 9 and 10, the arm is mounted on the threaded shafts (165) and has a portion at one end (140, 141) abutting against a block (145, 146) as that shown in FIG. 10. When released the arms are capable of moving vertically about the shaft and relative to the block. The arms are shaped so to fit around a portion of the block. This should permit the adjustment of the location of the base riser via the wheels (180) whilst permitting the riser to be locked into position when desired. As the wheels (180) are wound up their shafts, the base riser sitting on top of the wheels also rise, lifting the arms so long as the wing nuts are loose enough to allow for this. When wing nuts are tightened they push against the arms (148, 149) thereby forcing the ends of arms into the channels so that they engage attachment surfaces in the support member, such as the surfaces in the lower channels (13, 15).

The arms may be biased away from engaging the attachment surface by a biasing means such as a spring (160). In such an arrangement the arm will need a means for countering the bias and for ensuring the secure engagement of the arm to the attachment surface. One such means is a threaded shaft (165) that passes though the arm and is fixed into the base plate and has a wing nut (167) mounted thereon. Typically the shaft (165) will need to pass through an oval shaped hole in order to allow for some movement of the arms.

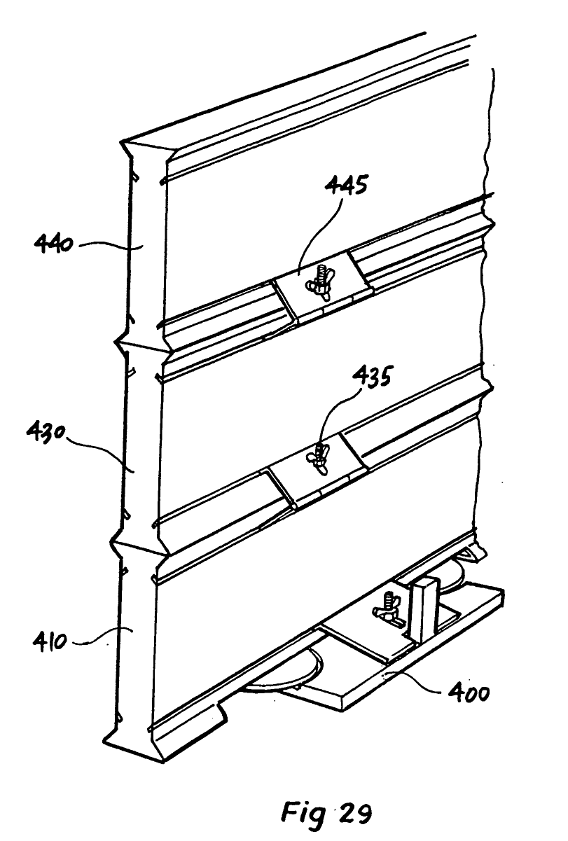

The first support member may take the form of a modified side form member. A portion of the side form may need to be removed from the bottom resting surface and nearby fillet surfaces in order to permit the first or bottommost support member to fit around the securing device. A more detailed description of this is set out below with reference to FIGS. 28 and 29.

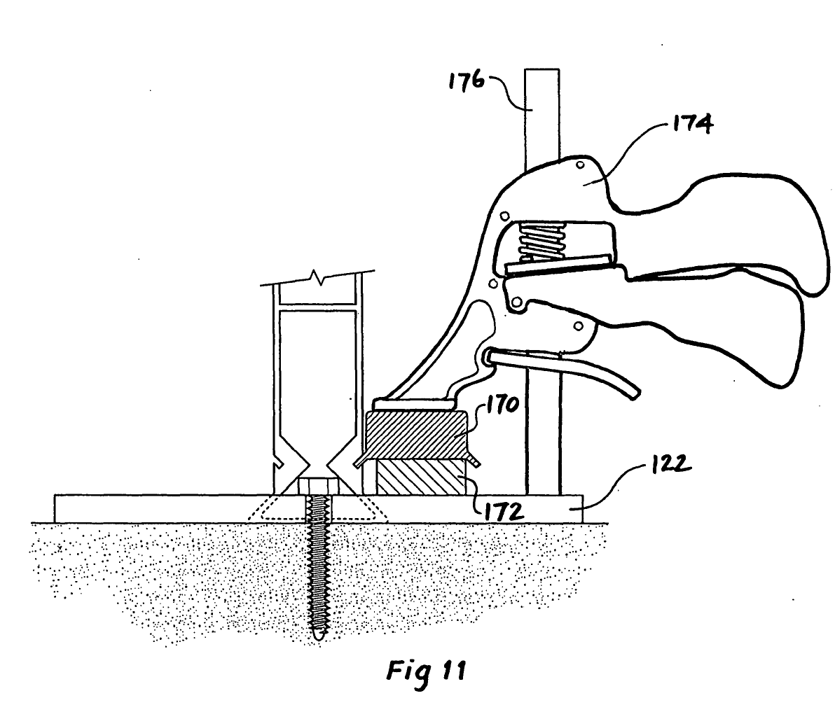

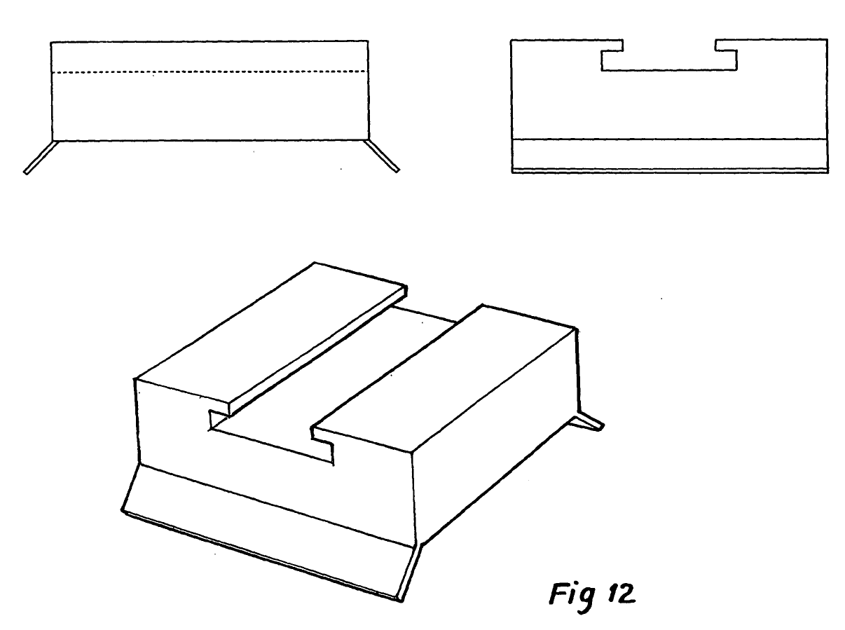

Other types of securing devices may be used to secure the first support member to an underlying surface. An example of another device is shown in FIG. 11. This arrangement uses an engagement unit (170) to engage the attachment surface. The engagement unit (170) is located on a spacer (172) located on the base plate. A clamp (174) is located on a shaft (176) and clamps thereto. Preferably the device will include a clamp on both sides of the side form support member. The engagement unit is shown in more detail in FIG. 12.

Alternatively, the engagement unit (170) is locked into place on the clamp (174) by using a recess on the top of the unit to engage the clamp. The clamp could be rotationally mounted on the shaft (176) or it may only be capable of vertical movement. In the latter instance, the engagement unit would disengage from the support member by being pulled toward the top of the shaft (176), possibly whilst the clamp is raised. This arrangement would not require the use of a spacer (172).

Further alternative arrangements are also possible and should be considered a variation of the invention.

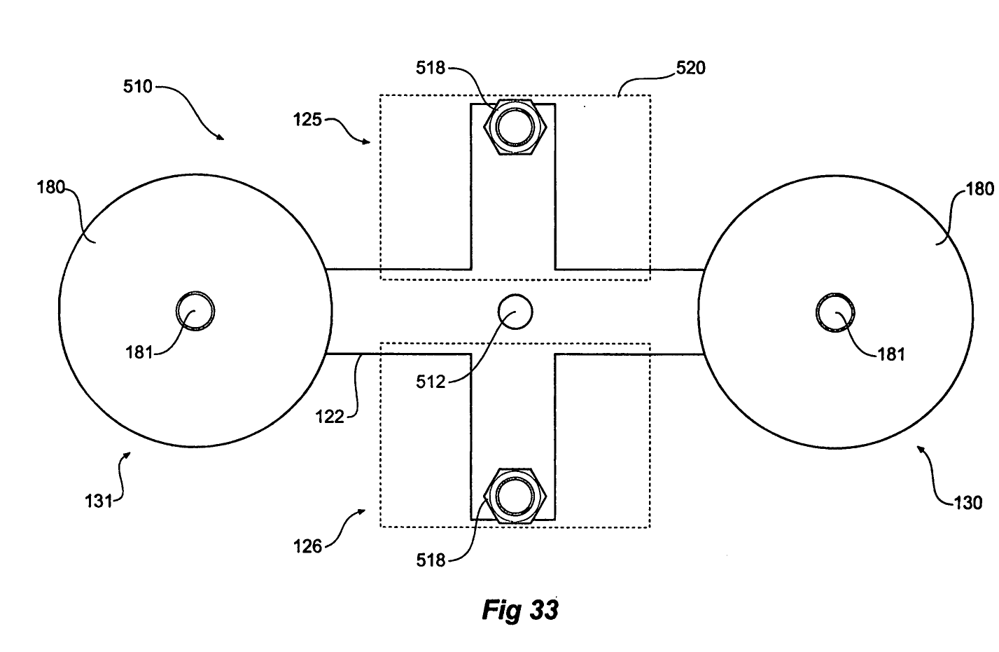

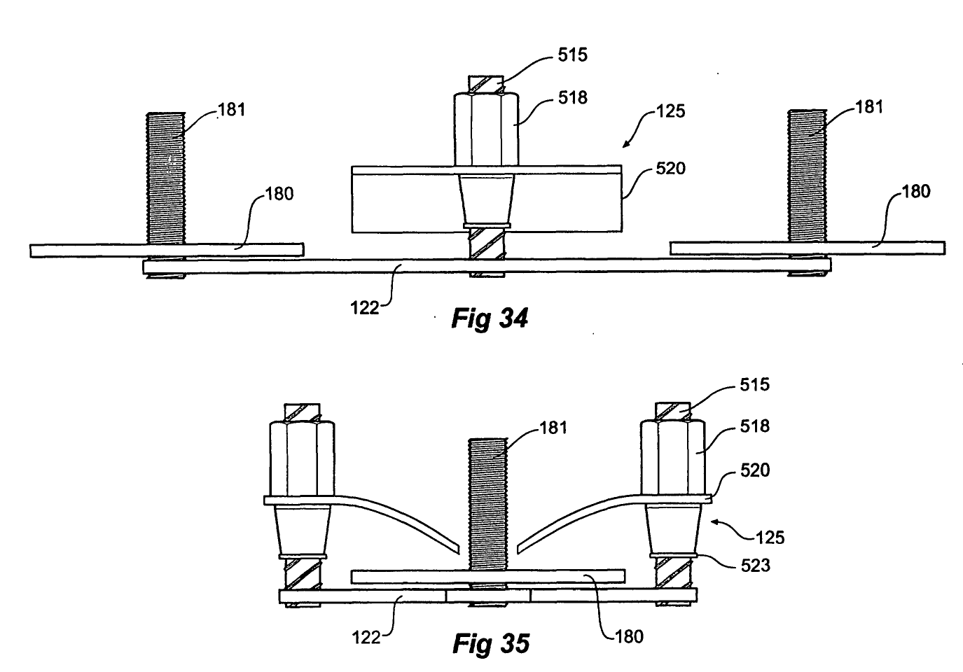

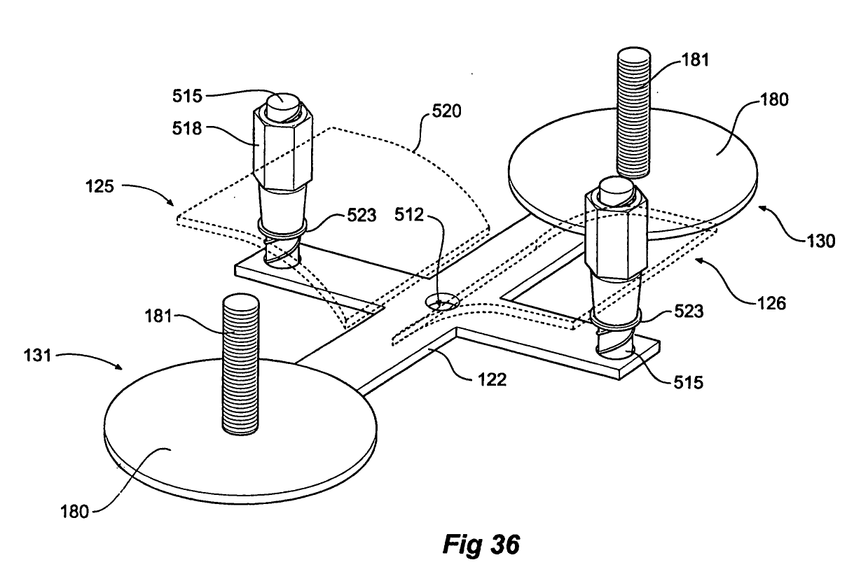

FIGS. 33 to 36 depict another alternative arrangement for holding a side form support member to a fixed position relative to the ground. This arrangement is similar to that depicted in FIGS. 8 to 10.

The assembly (510) includes a base plate (122) and includes a side form support member level adjustment means (130, 131) and side form support member clamping means (125, 126).

The base plate (122) includes a bore (512) through which a securing bolt may pass to affix the base plate and thus the assembly to an underlying surface. A ‘t’ shaped base plate is preferably used as it reduces the weight of the assembly, improves user access to the levelling devices (130, 131) and reduces the contact area of the base plate with the underlying surface and thereby reduces the available area for pebbles, stones or other pieces to fit between the plate and the underlying surface. The base plate could be made of any suitably strong material having high tensile strength, resistance to deflection and to weathering. One suitable material is BIS alloy, but it is envisaged that other alloys or some plastics may be suitable. This product has a three times higher reduction in flex than bright steel and as such it is possible to use a 5 mm plate instead of a standard steel plate of roughly 15 mm thick. The device incorporates a side form support member levelling device in the form of two wheels or disks (180) mounted on threaded shafts (181). The threaded shafts are affixed to the backing plate. The rotation of the disks will raise or lower the disk relative to the shaft and thereby raise or lower a side form member resting thereon.

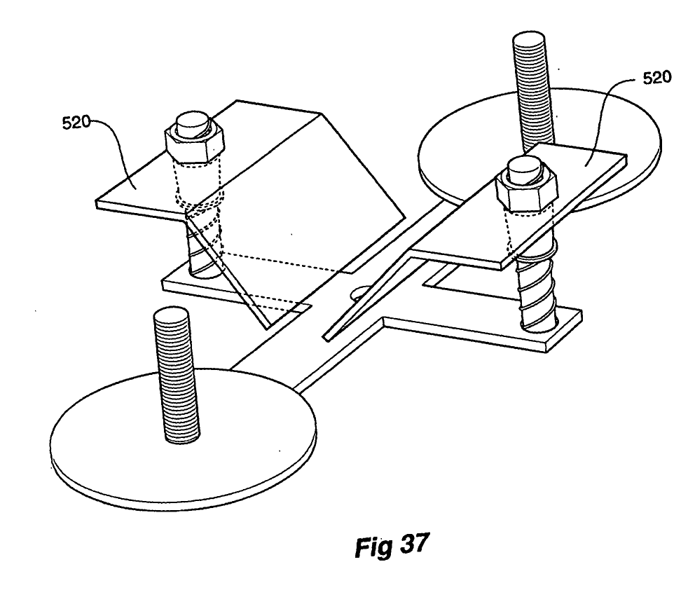

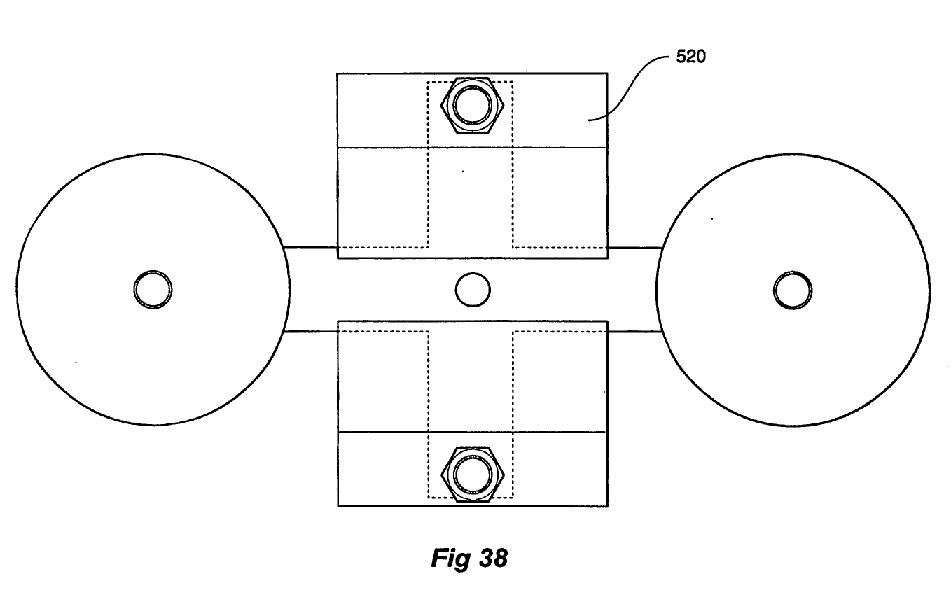

The assembly also includes two clamping members (125, 126). Each of these members comprises a threaded shaft (515) having a locking lug (518) affixed thereto. The locking lug has an upper portion adapted for turning by hand or with an appropriate adjuster and a lower portion having a frusta-conical shape. The clamping member also includes an arm (520) in the form of a curved locking plate. Other locking plate shapes may also be used such as that used in the assembly depicted in FIGS. 37 and 38.

One end of the arm is intended to engage an attachment surface and a support member such as one or more of the surfaces of the lower channels (13, 15) of the member depicted in FIG. 1. The locking plate also includes an aperture therein through which passes the threaded rod (515) and the frusta-conical portion of the locking lug (518). The locking lug may also be fitted with a restraining washer that is larger than the aperture in the locking plate. This arrangement permits the locking plate to be repositioned or moved about the locking lug without separating from the lug. Alternative restraining means could also be used such as a spot weld at or near the bottom of the frusta-conical shape. The restraining washer (523) should be larger than the size of the aperture in the locking plate.

In use a side form support member is fitted on to the assembly and is levelled by using the levelling devices. The member is also clamped into position by the free ends of the locking plates engaging an attachment surface of the side form support member.

Preferably the threaded shaft (515) is 16 mm threaded “Reidbar”™ made by Reid Engineering Systems Ltd or Reid Construction Systems Pty Ltd or a “Williams Bar”™ made by Williams Form Engineering Corporation. An appropriately threaded Reid™ nut or coupler is used in conjunction with such a bar. The nut may be fitted with a shaft or lever arm (not shown) to assist in the manual operation of the nut. One of the advantages of using this system is that the threading of the shaft is such that the appropriately coupled lug or nut requires only a small amount of rotation in order to travel a significant distance on the shaft.

The locking nuts depicted in the figure are preferably Reid™ nuts which have been lathed at one end to provide the frusta-conical portion.

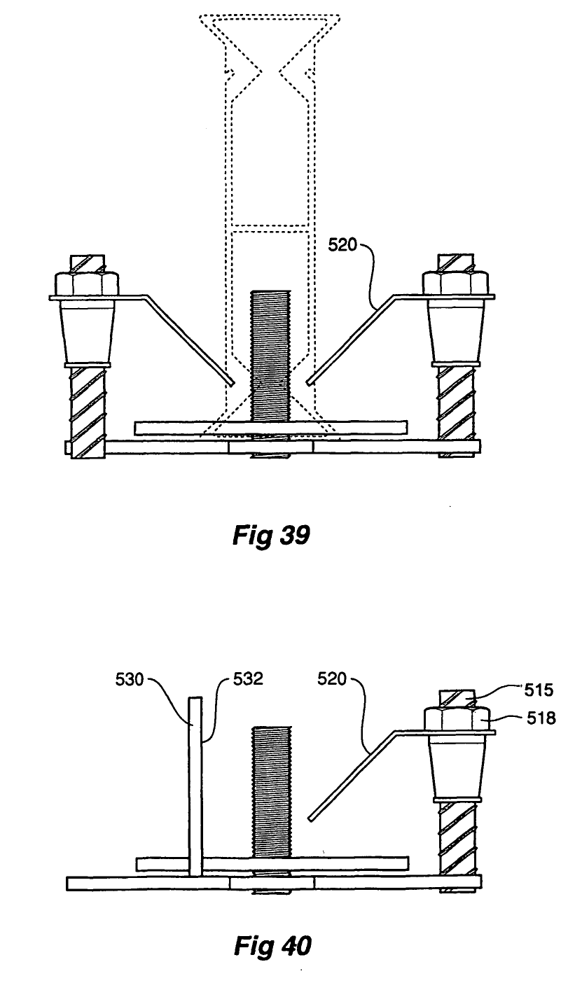

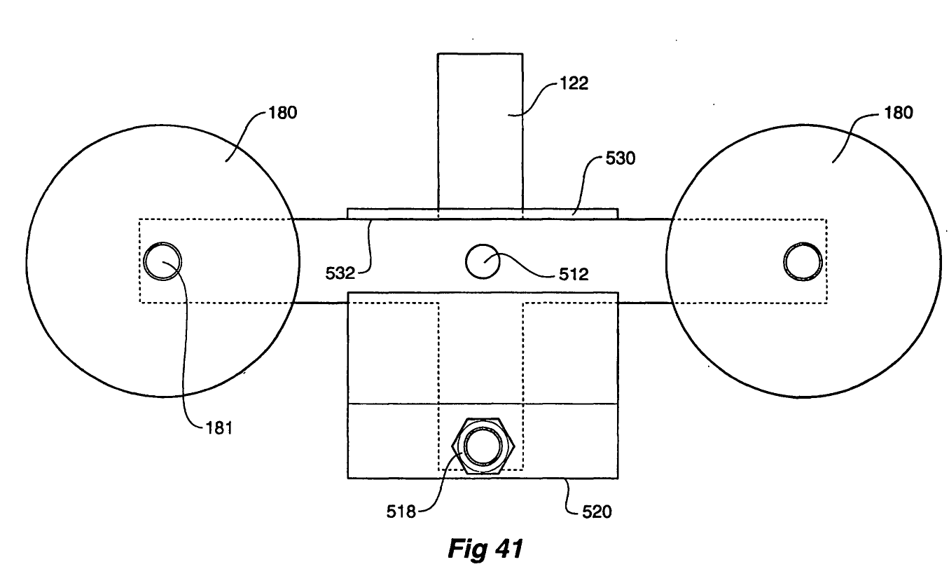

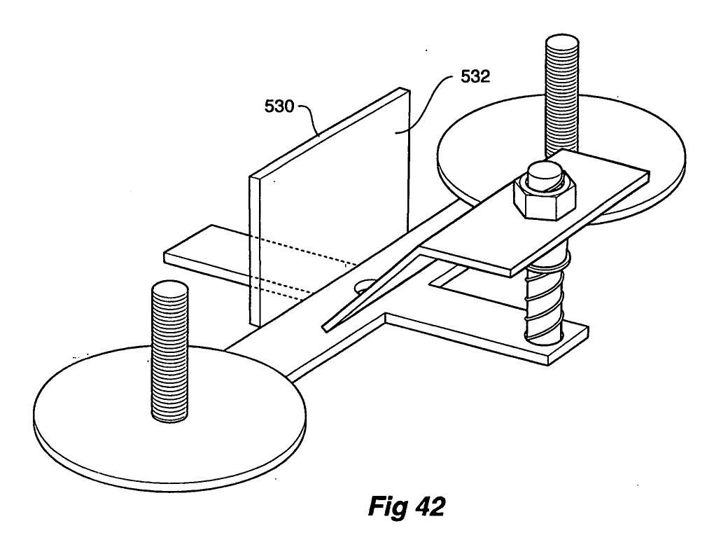

Another alternative securing device is depicted in FIGS. 40 to 42. This device uses one operable clamping member, of the type used in FIGS. 37 to 39. The clamping member includes a Reidbar™ threaded shaft (515) attached to a base plate (122). The clamp also includes a Reidbar™ nut (518) with an arm that acts as a locking plate (520).

The securing device also includes the side form support member levelling device in the form of two wheels or disks (180) mounted on threaded shafts (181).

Unlike the earlier securing devices, this variation dispenses with a second operable clamp member. Instead the device uses a vertical planar flange (530). In combination with the operable clamp, the flange should act to restrain movement of an attached support member.

It is intended that the side surface of a first support member would contact the inner surface (532) of the flange. Where the support member is sourced from a side form member such as that described in FIG. 1 or 30, at least portion of the bottom surface (5) together with the fillet sides (32, 36) would need to be cutaway from the side form member.

This modification should allow the modified side form member to sit above or bridge over the securing member, similar to that depicted in FIG. 28.

The contact of a portion of a planar, vertical side surface (7 or 9) of a modified side form member against the planar, vertical flange should prevent tilting of the side form in one axis. However it should permit the controlled adjustment of the tilt of the side form member in another axis by the levelling device. The engagement of the clamp should prevent any further movement.

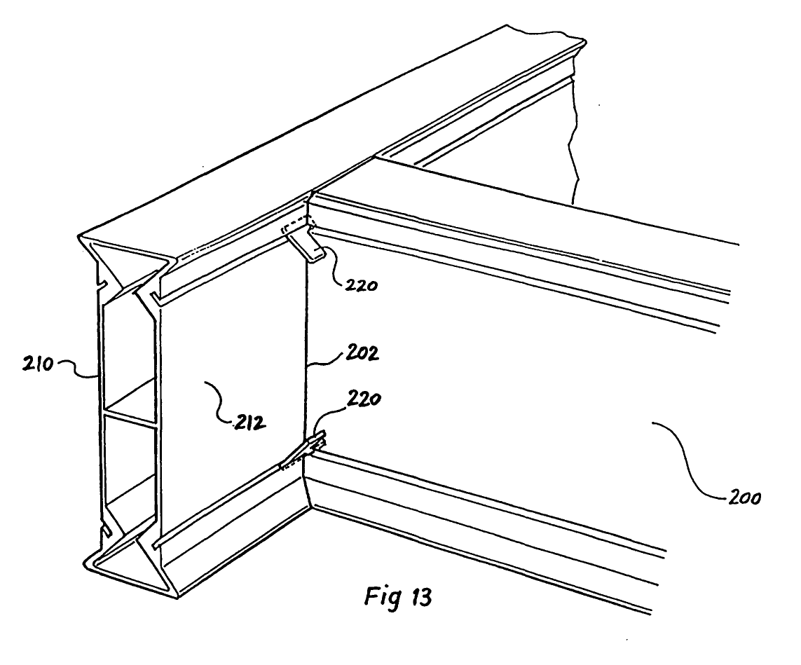

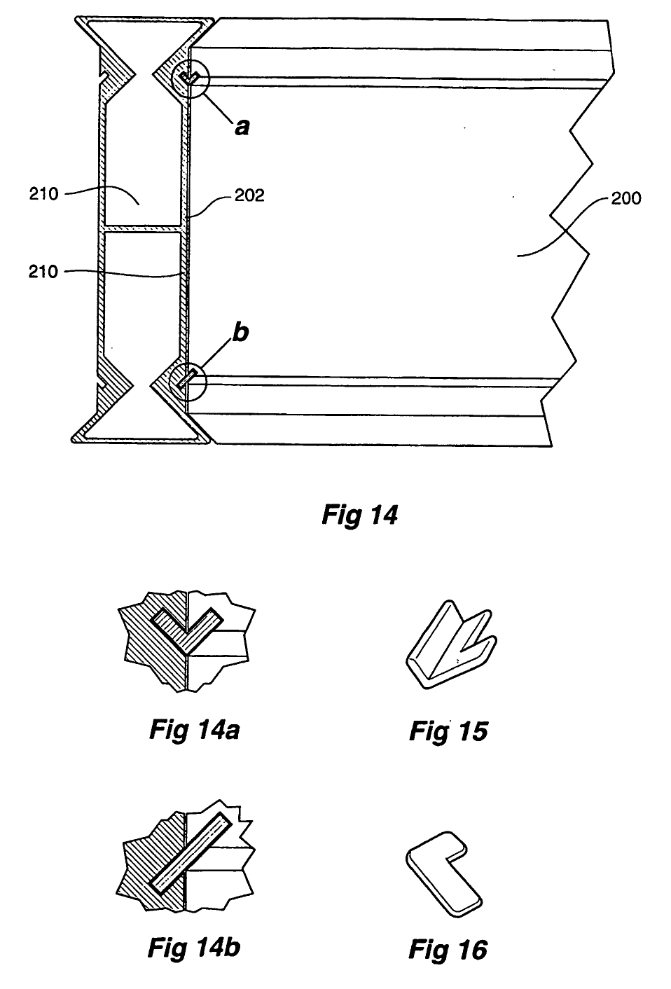

FIGS. 13 to 16 show a means of having a support member (200) support a side form member (210). In this example the support member directly contacts the side form member. It is envisaged that other arrangements are possible wherein the support member will support the side form member via an intermediate unit such as a linking device. Such a device may need to be used if the support member and the side form member cannot interfit due to the side form member being run at an angle. Alternatively the bolt (133) that holds down the locking down plate (122) of FIG. 8 could be loosened. The locking plate could be rotated to ensure the support member was at a 90° angle to the angle of the side-form. This would also work on if the panel in question were one of a stack of panels as it would not matter the below support members were moved once the lower panels have set.

In the FIGUREs the contacting end of the support member (202) is shaped to interfit the support contacting side of the side form member (212), but this is not essential. The interfitting shape may provide sufficient support to permit the use of the framework structure. However it is often desirable to fix the two members together. In that approach keys (220) may be used to so fix the members together.

Preferably the keys will engage an attachment surface of each of the members and thereby fix them together. If the members include attachment surfaces formed by using channels then this will provide a suitable means for affixing the members together. A key can by slipped into a channel in the side form member and pushed into a channel in the support member. The keys may be custom designed such as that shown in FIG. 15 or may simply be a small piece of metal such as that shown in FIG. 16. When the side form and support members are extruded from the same die it is envisaged that it will be necessary to add slots into the contact end of support member in order to permit the use of non-custom designed keys.

The keys may be used on both sides of the support member or only on one side.

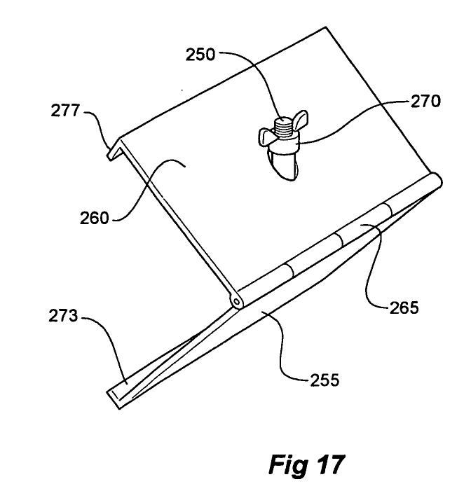

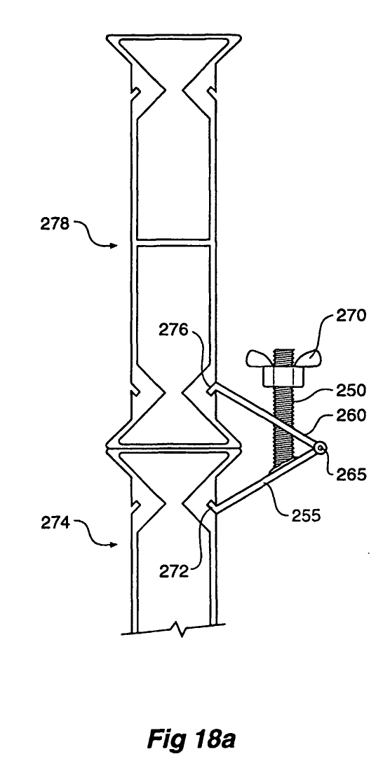

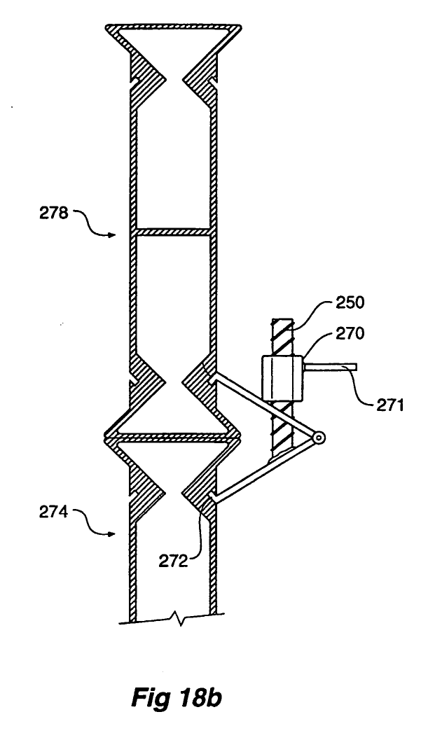

FIGS. 17 and 18a depict an inter-member securing device of the invention. The device has a threaded shaft (250) fixed at one end to a first arm (255). The device also includes second arm (260) rotatably connected (265) at a pivot point to the first arm (255). The shaft (250) passes through the second arm and is capped with a wing nut (270). Typically the hole will need to be elongate shaped, such as an oval in order to permit relative movement of the arms. The free ends (273, 277) of the arms are bent to engage an upper channel (272) of a first support member (274) and the lower channel (276) of an adjacent member (278) mounted onto the first member. The device may include a biasing means (not shown) between the arms to open the arms.

In use the end of one arm of the device is fitted in a channel and the wing nut or other fastener nut is wound down the shaft to engage the end of other arm onto an attachment surface in the other channel. Once the device has been fitted and secured to the members the wing nut prevents the opening of the arms and thereby keeps the members in a secured relationship.

FIG. 18b depicts a preferred form of the inter-member securing device. The shaft (250) is a Reidbar™, or other shaft threaded at a large pitch. A Reidbar™ nut (270) is used in place of a wingnut. The nut includes a shaft (271) welded thereon for easy turning of the nut.

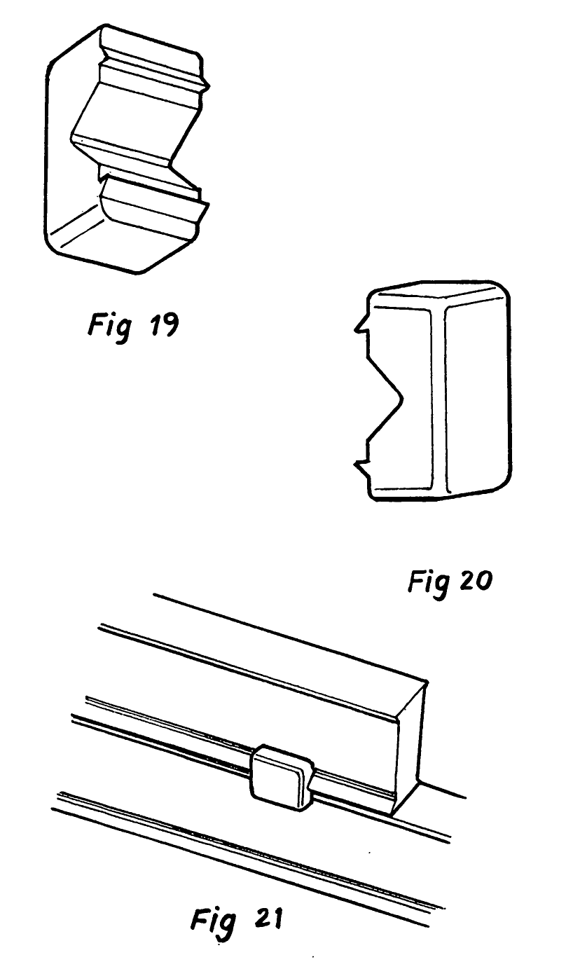

FIGS. 19 to 21 show an alternative device for securing two members together. The device may be flexed and clipped into the channels of two adjacent members. Alternatively the device may be attached at a free end of the members and slid along the channels.

Other methods for releasibly securing two support members together can be envisaged and should be considered within the scope of the invention. When the attachment surface is located on a flange extending from the support members known clamps such as a G clamp or pistol grip clamp may be used.

FIGS. 22 to 26 depict various linking devices for use with the side forms of the invention. These linking devices (60) are normally used to link and secure the end of a side form member into a fixed position relative to another side form member. In the prior art Tiltform™ system the two side-forms are held together to form a 90° corner by drilling holes into side form members and screwing an angle bracket onto the support sides of two abutting side form members.

The linking device avoids the need to damage the side form members by using the attachment surfaces located on the supporting side of the side form members.

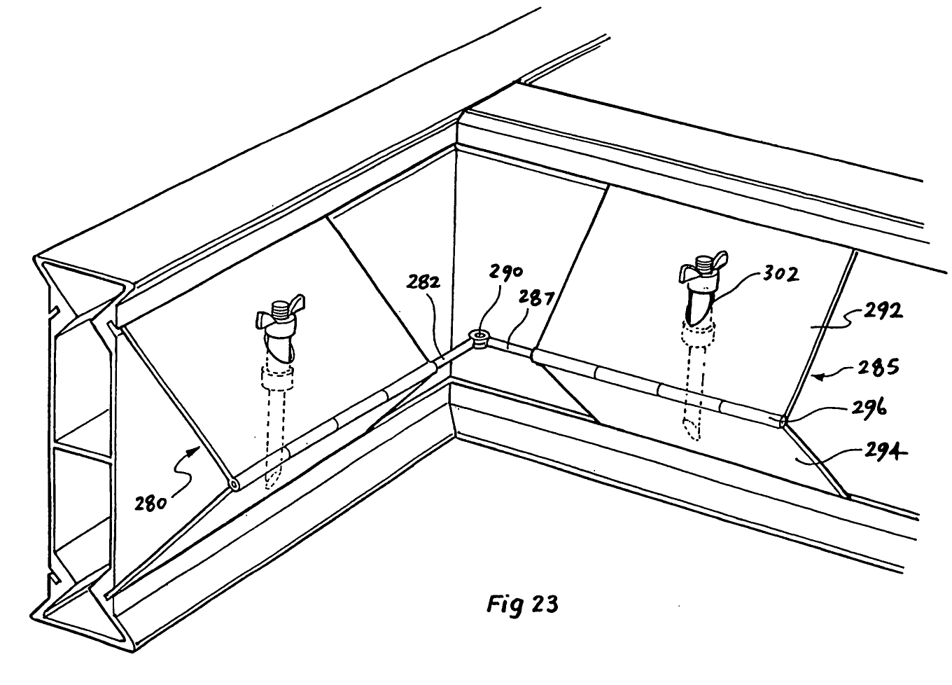

With reference to FIGS. 22A, 22B and 23 the device (60) has two clamping elements (280, 285) mounted on shafts (282, 287) that are pivotally joined together (290). Each clamping element may rotate about the pivot point (290). The clamping elements themselves are in essence modified hinges and include a first arm (292) and a second arm (294) pivotally joined about an axis (296). The clamping elements also include a threaded shaft (297) fixed at one end (298) to the second arm. The shaft passes through an elongate hole (302) in the first arm and sheath (300) is fitted thereto. The sheath has two bosses, an upper (304) and a lower (306) at either end, both with an outer circumference that exceeds the diameter of the hole. The upper boss is fitted with wings (308) in order to facilitate the rotation of the sheath component.

In use the clamping elements are secured to a side form member by fitting the ends of the arms within the upper and lower channels in the member and then turning the wing nut about the threaded shaft to move the sheath and the lower boss up the shaft until the lower boss contacts the underside of the first arm. This will prevent rotational movement of the ends of the arms towards each other and lock the arms within the channels.

The other clamping element can likewise be secured to another side form member, thereby linking the two members.

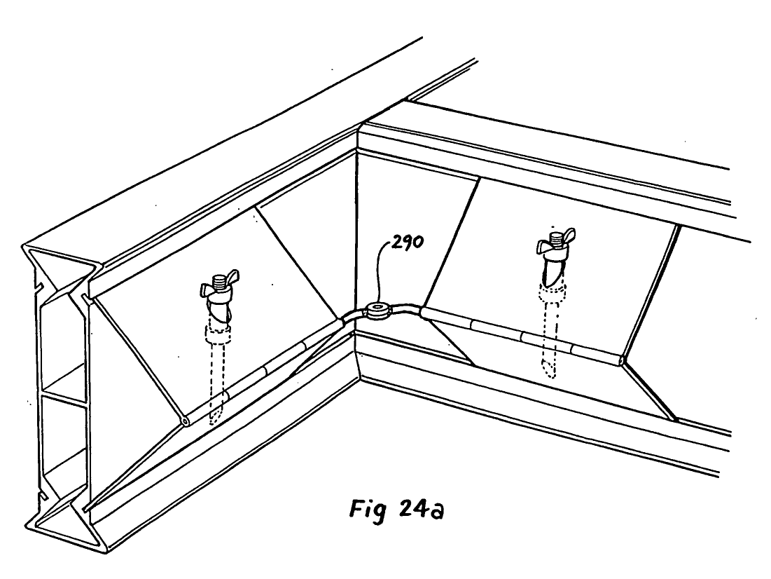

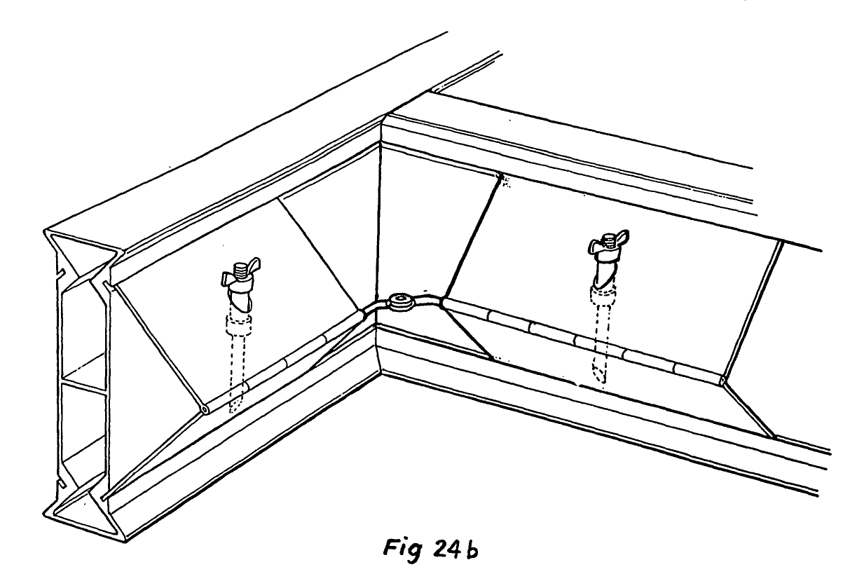

A number of variations of the linking device are possible. One preferred form simply involves increasing the pitch of the shaft thread. Preferably a Reidbar™ is used. Another variation is depicted in FIG. 24.

FIG. 24a depicts a device (60) having the clamping elements linked by an offset pivot point (290). FIG. 24b depicts a linking device with an offset pivot point and one clamping element longer than the other. It is envisaged that these variations may provide linking devices that are more suitable for certain applications.

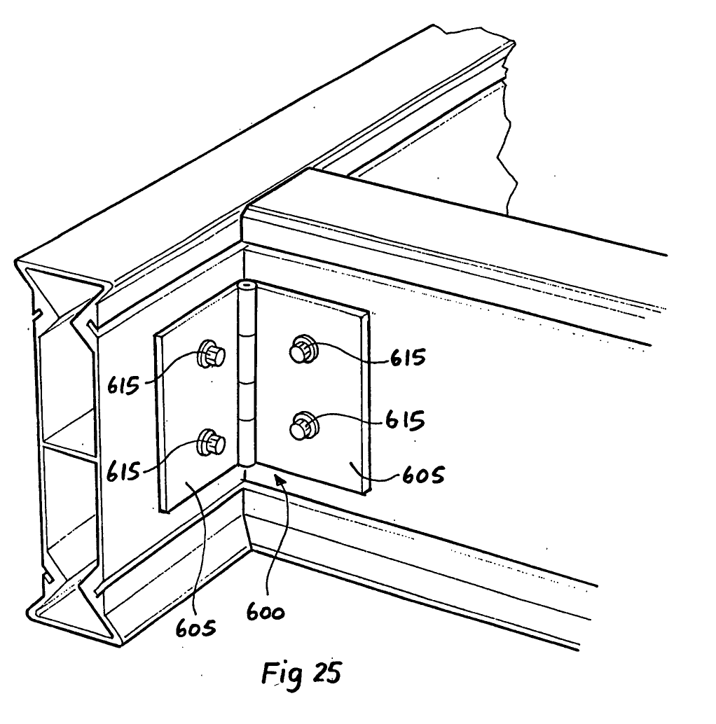

FIG. 25 depicts another type of linking device, earlier referred to in respect of FIG. 4b as a hinge joiner (600). The device is a simple hinge having two leaves (605) which have been machine screwed (615) or otherwise affixed to the sides of two nearby side form members.

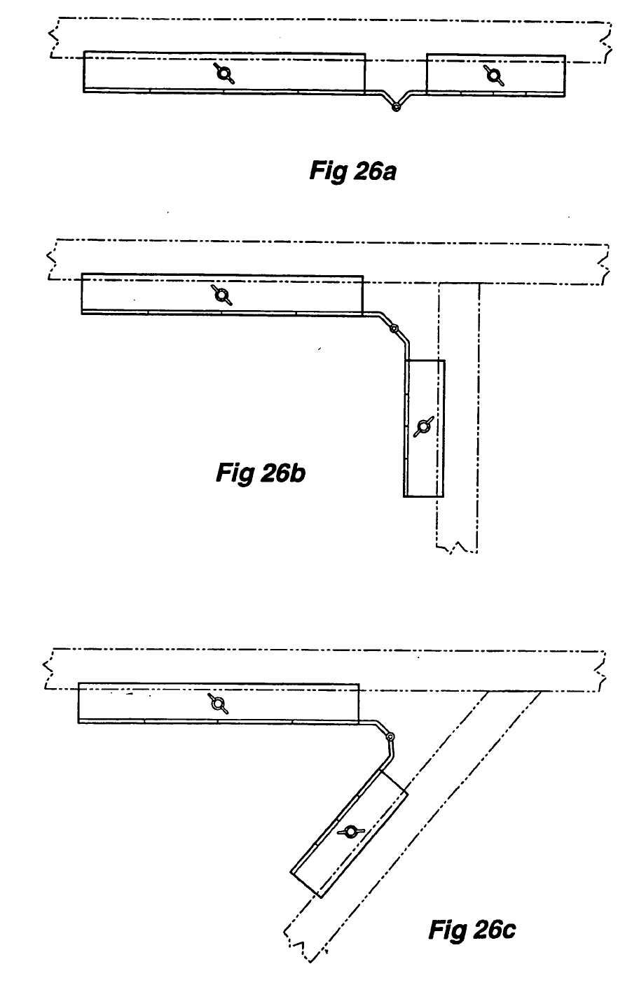

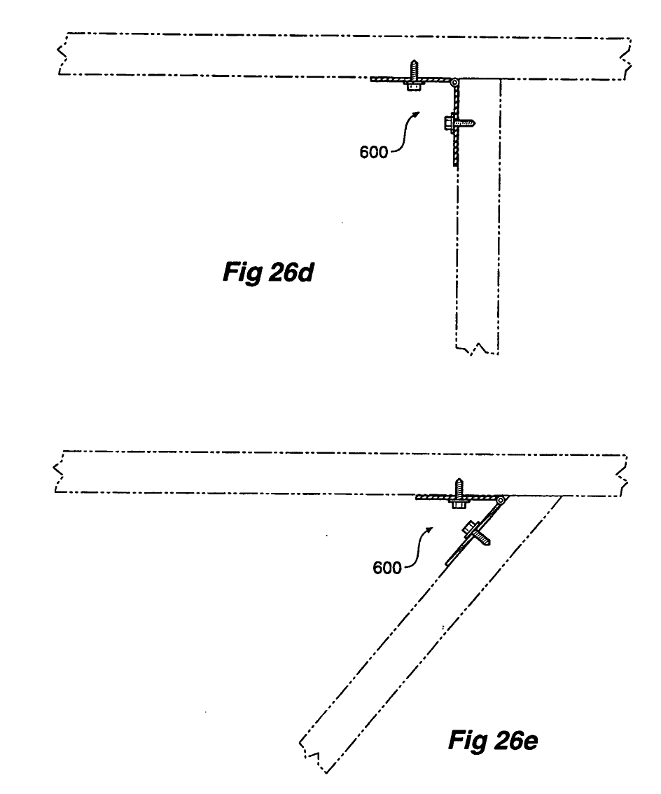

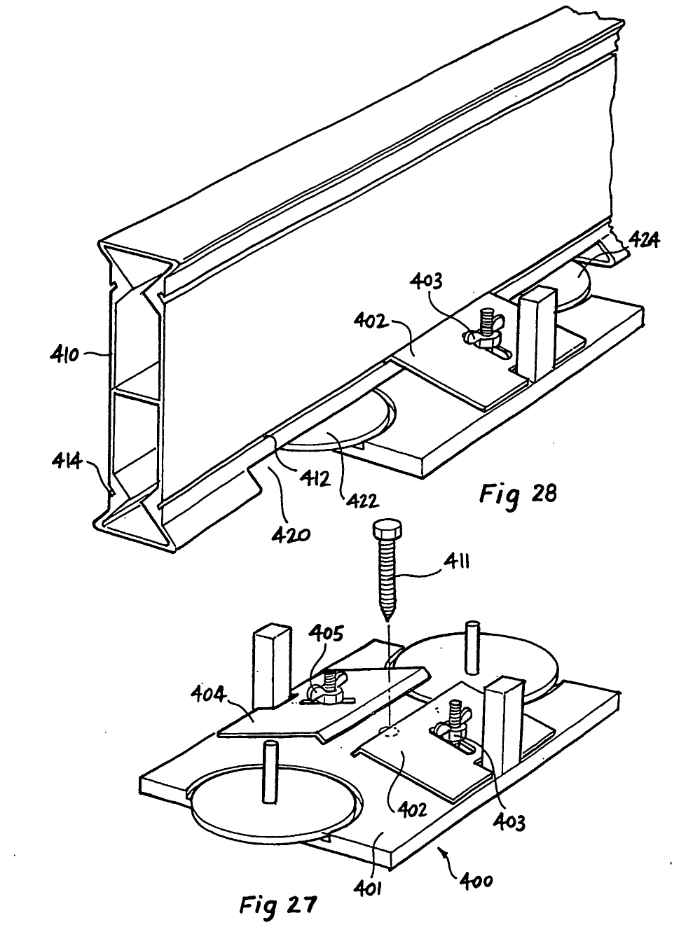

The linking device may be used in a number of different applications. As shown in FIG. 4 (60) and FIG. 26A it may be used to join the ends of two side form members together to form a longer member. Alternatively as shown in FIG. 4 and FIG. 26B it may be used to form right angle corners. Advantageously it may also be used to produce formwork with other angles such as that shown in FIG. 26C. FIGS. 26D and 26E depict methods of using a hinge joiner (600) to form corner joints with side form members.

FIGS. 27 to 29 depict steps in the process of securing side form support members to an underlying surface.

In FIG. 27 a surface-to-member securing device (400) is positioned on a supporting surface and the anchor plate (401) is bolted thereto with a bolt (411).

In FIG. 28 a bottom support member (410) is secured to the supporting surface by the surface-to-member securing device (400). The arms (402, 404) of the device have been fitted within the channels (412, 414) and held in position by the wing nuts (403, 405).

The bottom or first support member (410) has a section (420) removed from the bottom surface and lower side in order to permit the member to fit over the anchor plate and permit it to rest on the underlying surface.

Once the support member has been secured to the securing device the support member is levelled by adjusting the anchor plate levelling wheels (422, 424).

FIG. 29 depicts the use of additional side form support members (430, 440) which are held in a fixed position with respect to the underlying surface. The bottom or first support member (410) has been secured and levelled by the member-to-level securing device (400). The support member (430) has been secured to the level upper surface of the support member (410) by the inter-member securing device (435), as previously described with reference to FIG. 17. Another support member (440) has been secured to the level support member (430) by the inter-member securing device (445). The member is thus secured to member (410), and to the underlying surface.

The above description is provided for the purposes of exemplification only and it will be understood by a person skilled in this field that modifications and variations may be made without departing from the invention.

1. A formwork structure located on supporting surface, the structure having a side form perimeter including side form members, the perimeter defining a curable non-solid material retaining area; the formwork including side form support members that support the side form members, the side form support members being held in a fixed position relative to the supporting surface by a surface-to-member releasable securing device fixed to the supporting surface and which engages the side form member, characterised in that the side form member is adapted to permit another side form member to be secured thereto by one or more releasable inter-member securing devices, which are separate to the surface-to-member securing device.

2. The formwork of claim 1 wherein additional support members are secured on top of previously secured support members.

3. The formwork of claim 2 wherein each additional support member is secured by one or more separate inter-member securing devices.

4. A formwork structure located on supporting surface, the structure having a side form perimeter including side form members, the perimeter defining a curable non-solid material retaining area; the formwork including side form support members that support the side form members and being held in a fixed position relative to the supporting surface, the side form support members having a top support surface capable of supporting another side form support member thereon and a bottom resting surface for contacting the supporting surface of the formwork or another member's top support surface, characterised in that the side form support member is secured into a fixed position by using a securing device which engages to an attachment surface of the member which is a separate and distinct surface to the top support surface of the member.

5. A formwork structure of claim 4 wherein the securing means includes surface-to-member securing device for fixing to an underlying surface and being capable of releasibly securing a member.

6. A formwork structure of claim 4 wherein the securing means includes 5 inter-member securing device for secured member capable of securing another member to the secured member.

7. A surface-to-member securing device for use with formwork structures having a base plate for securing to an underlying supporting surface, a clamping element joined to the plate and capable of releasibly securing a side form support member, wherein the clamping element includes at least one arm that is capable of engaging an attachment surface of the member which is a separate and distinct surface to the top support surface of the member.

8. The device of claim 7 wherein the surface-to-member securing device releasibly engages the side form member.

9. The device of claim 8 wherein the side form support members support the side form members by having the end of one or more side form support members engage a portion of the side of a side form member.

10. The device of claim 9 wherein the device includes a level adjustment means for modifying the level of a side form support member secured to the 2o device.

11. The device of claim 10 wherein the base plate is capable of being secured to an underlying surface at a securing point and the level adjustment means is connected to the base plate and includes at least one leg having an adjustable length capable of contacting the underlying surface, such that adjusting the length of the leg will pivot the base plate about the securing point and change the level of the base plate and side form support members attached thereto.

12. The device of claim 10 wherein the base plate is capable of being secured to an underlying surface at a securing point and the level adjustment means is connected to the base plate and includes at least a side form support member contact device that is capable of being moved relative to the base plate and thereby change the level of side form support member relative to the base plate.

13. A side-form support member capable of engaging supporting a side-form that constitutes part of a formwork structure for retaining curable non-solid material, the member having a top support surface capable of supporting another member, a bottom resting surface for contacting and being supported by an underlying top support surface of a further member, and one or more attachment surfaces separate to and distinct from the top and bottom surfaces, wherein the attachment surfaces inter-member securing devices engage therewith and secure the member to adjacent member by attachment surfaces of the adjacent member.

14. The member of claim 13 having at least one channel having internal surfaces, that in part defines an attachment surface of the member.

15. The member of claim 14 having two opposed sides that extend from the top and bottom surfaces, each side having two channels therein, an upper channel located near the top surface and a lower channel located near the bottom surface.

16. The member of claim 15 wherein the member has a substantially “I” shape.

17. A member of claim 13 formed by extrusion.

18. A member of claim 13 wherein the support members and side-form members are the same in cross-section.

19. A side form member used in defining a perimeter for retaining curable non-solid material, the member having a top support surface capable of supporting another member, a bottom resting surface for contacting and being supported by an underlying support surface, the member having two opposed sides that extend from the top and bottom surfaces, a support side capable of being supported by one or more side-form support members, and a retaining side, wherein the retaining side is capable of having side-moulds affixed thereto.

20. The side form of claim 19 wherein the retaining side includes two channels therein, an upper channel located near the top surface and a lower channel located near the bottom surface by which a side-mould may be affixed thereto.

21. The side form of claim 20 wherein the support side has two channels therein, an upper channel located near the top surface and a lower channel located near the bottom surface, the channels facilitating the attachment of one or more side form support members to the side-form members.

22. A formwork structure that uses side-form members of claim 19.

23. A formwork structure that uses side form support members of claim 13.

24. A formwork structure for use in the manufacture of a multiple layer stack of construction panels and structures, preferably concrete construction panels, the structure having a plurality of side form support members of claim 13.

25. The formwork structure of claim 24 that includes a plurality workmate surface-to-member securing devices and a plurality of member-to-member securing devices.

26. A method of constructing formwork having side form members and side form support members wherein adjacent support members are secured together by using individual clamps between adjacent support members.
